(19) United States
(12) Patent Application Publication
(10) Pub. No.: US 2013/0017839 A1
(43) Pub. Date: Jan. 17, 2013

(54) ELECTRONIC DEVICE AND METHOD OF OPERATING THE SAME

(71) Applicants: Gunho LEE, Seoul (KR); June Ho CHOI, Seoul (KR)

(72) Inventors: Gunho LEE, Seoul (KR); June Ho CHOI, Seoul (KR)

(73) Assignee: LG ELECTRONICS INC.

(21) Appl. No.: 13/221,377

(22) Filed: Aug. 30, 2011

(30) Foreign Application Priority Data
Jul. 11, 2011 (KR) 10-2011-0068449

(51) Int. Cl. H04W 24/00

(52) U.S. Cl. 455/456.1

(57) ABSTRACT

An electronic device and a method of operating the electronic device are provided that provide location-based acquaintance information by outputting acquaintance information associated with a specific location among acquaintance information included in a contact list.

This nonprovisional application claims priority under 35 U.S.C. §119(a) on Patent Application No. 10-2011-0068449 filed in Republic of Korea on Jul. 11, 2011, the entire contents of which are hereby incorporated by reference.

### BACKGROUND

1. Field

The embodiments of this disclosure are directed to an electronic device and a method of operating the electronic device, which effectively provide acquaintance information when an acquaintance included in a contact list is located at a specific location.

2. Related Art

As various functions are added, electronic devices, such as personal computers, laptop computers, mobile phones, etc., converge into multimedia players that are capable of image or moving picture capturing, play of music or video files, game playing, or receipt of broadcasts.

Such electronic devices may be classified into mobile terminals and stationary terminals according to mobility. The mobile terminals include handheld terminals and vehicle-mounted terminals.

For supporting and enhancing functions of an electronic device, it is considered to develop the electronic device in light of structure and/or software.

Recent electronic devices provide map information for users' desired locations based on digital map information.

However, the conventional electronic devices provide only the map information desired by users but fail to effectively provide information on the users' acquaintances in association with the map information.

### SUMMARY

Embodiments of this disclosure provide an electronic device and a method of operating the electronic device that, when receiving a request for map information for a specific location, provide acquaintance information associated with the specific location among acquaintance information included in a contact list corresponding to the specific location and that output a message of notifying existence of the acquaintance included in the contact list when the acquaintance's location is located within a predetermined area of the current location.

The embodiments of this disclosure are not limited thereto, and other embodiments of this disclosure are apparent to one of ordinary skill in the art from the detailed description.

According to an embodiment of this disclosure, there is provided an electronic device comprising an output unit, and a controller is configured to output acquaintance information associated with a specific location among acquaintance information included in a contact list on map information through the output unit when receiving a request for the map information for the specific location.

According to an embodiment of this disclosure, there is provided an electronic device comprising an output unit, and a controller is configured to output a message for notifying existence of an acquaintance through the output unit when a location of the acquaintance stored in a contact list is included within a predetermined area of a current location.

According to an embodiment of this disclosure, there is provided a method of operating an electronic device comprising receiving a request for map information for a specific location, and outputting acquaintance information associated with the specific location among acquaintance information included in a contact list on the map information through the output unit.

According to an embodiment of this disclosure, there is provided a method of operating an electronic device comprising determining whether an acquaintance stored in a contact list is located within a predetermined area of a current location, and outputting a message for notifying existence of the acquaintance through an output unit when it is determined that the acquaintance is located within the predetermined area.

According to the embodiments of this disclosure, the electronic device and method of operating the electronic device, when receiving a request for map information for a specific location, provide acquaintance information associated with the specific location among acquaintance information included in a contact list corresponding to the specific location, thus enabling a search for location-based acquaintance information.

Further, the electronic device and method of operation the electronic device output a message of notifying existence of the acquaintance included in the contact list when the acquaintance's location is located within a predetermined area of the current location, thus enabling a search for information on an acquaintance located within a predetermined distance of the current location.

### BRIEF DESCRIPTION OF THE DRAWING

The implementation of this document will be described in detail with reference to the following drawings in which like numerals refer to like elements:

FIG. 1 is a block diagram illustrating an electronic device according to an embodiment of this disclosure;

FIG. 2 is a flowchart illustrating a method of operating an electronic device according to an embodiment of this disclosure;

FIG. 3 illustrates a menu window according to an embodiment of this disclosure;

FIG. 4 is a flowchart for describing step S110 more specifically;

FIG. 5 illustrates examples of a user interface for setting an interested area according to an embodiment of this disclosure;

FIG. 6 is a view for describing a contact list according to an embodiment of this disclosure;

FIG. 7 illustrates an example of the current location database according to an embodiment of this disclosure;

FIG. 8 is a view for specifically describing step S118;

FIG. 9 illustrates an example of a resultant window according to an embodiment of this disclosure;

FIG. 10 illustrates an example of a user interface according to an embodiment of this disclosure;

FIG. 11 is a view for describing generating an appointment request message according to an embodiment of this disclosure;

FIGS. 12A, 12B, and 12C are views for describing an acquaintance search reference according to an embodiment of this disclosure;

FIG. 13 is a flowchart for describing a method of operating an electronic device according to an embodiment of this disclosure;

FIG. 14 illustrates a message according to an embodiment of this disclosure; and

FIG. 15 illustrates an interface outputting peripheral acquaintance information according to an embodiment of this disclosure.

### DETAILED DESCRIPTION

The embodiments of this disclosure will become more apparent from the detailed description taken in conjunction with the accompanying drawings. Various modifications may be made to this disclosure. Hereinafter, several embodiments will be described in detail with reference to the accompanying drawings. The same reference numerals refer to the same or substantially the same elements throughout the specification and the drawings. The specific description on well known functions or structures associated with this disclosure will be omitted that is determined to cause the gist of this disclosure to be unnecessarily unclear or vague. As used herein, numbers (for example, one, two, three . . . , or first, second, third, . . . ) are used only to distinguish one element from another.

When one element is “connected to” or “coupled to” another element, it can be directly connected or coupled to the other element or intervening elements may be present therebetween. In contrast, when an element is referred to as “directly connected to” or “directly coupled to” another element, there are no intervening elements therebetween.

In the following description, suffixes “module” and “unit” are given to components of the mobile terminal in consideration of only facilitation of description and do not have meanings or functions discriminated from each other.

As used herein, the electronic device includes a mobile phone, a smart phone, a laptop computer, a terminal for digital broadcast, a PDA (Personal Digital Assistant), a PMP (Portable Multimedia Player), a navigation system, etc.

Hereinafter, embodiments of this disclosure will be described in further detail with reference to the accompanying drawings.

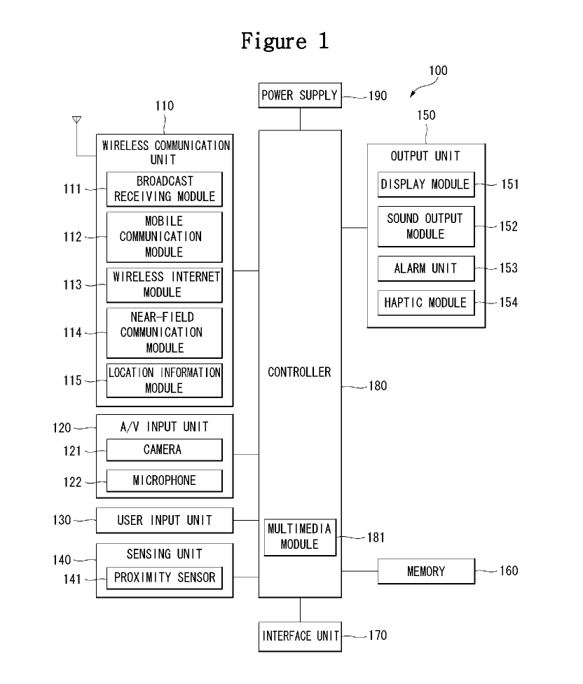

FIG. 1 is a block diagram illustrating an electronic device according to an embodiment of this disclosure.

The electronic device 100 includes a wireless communication unit 110, an A/V (Audio/Video) input unit 120, a user input unit 130, a sensing unit 140, an output unit 150, a memory 160, an interface unit 170, a controller 180, and a power supply 190. It should be noted that the elements shown in FIG. 1 are not inevitable and more or less elements may be included in the electronic device 100.

Each element is sequentially described in greater detail.

The wireless communication unit 110 includes one or more modules that enable communications between the electronic device 100 and a wireless communication system or between the electronic device 100 and a network in which the electronic device 100 is located. For example, the wireless communication unit 110 includes a broadcast receiving module 111, a mobile communication module 112, a wireless Internet module 113, a near-field communication module 114, and a location information module 115.

The broadcast receiving module 111 receives a broadcast signal and/or broadcast-related information from an external broadcast management server through a broadcast channel.

The broadcast channel includes a satellite channel and a terrestrial channel. The broadcast management server includes a server that generates and broadcasts the broadcast signal and/or broadcast-related information or a server that receives a previously generated broadcast signal and/or broadcast-related information and transmits the signal or information to terminals. The broadcast signal includes a TV broadcast signal, a radio broadcast signal, a data broadcast signal, and a combination thereof.

The broadcast-related information includes information relating to a broadcast channel, a broadcast program, or a broadcast service provider. The broadcast-related information may be provided through a mobile communication network. Under such circumstance, the broadcast-related information can be received by the mobile communication module 112.

The broadcast-related information may be provided in various forms, such as, for example, EPG (Electronic Program Guide) for DMB (Digital Multimedia Broadcasting) or ESG (Electronic Service Guide) for DVBH (Digital Video Broadcast Handheld).

The broadcast receiving module 111 receives a broadcast signal using various broadcast systems. For example, the broadcast receiving module 111 can receive digital broadcast signals using digital broadcast systems, such as DMBT (Digital Multimedia Broadcasting Terrestrial), DMBS (Digital Multimedia Broadcasting Satellite), MediaFLO (Media Forward Link Only), DVBH(Digital Video Broadcast Handheld), or ISDBT(Integrated Services Digital Broadcast Terrestrial). According to an embodiment, the broadcast receiving module 111 is configured to fit for other broadcast systems that provide broadcast signals as well as the above-listed digital broadcast systems.

The broadcast signal and/or broadcast-related information received through the broadcast receiving module 111 are stored in the memory 160.

The mobile communication module 112 communicates wireless signals with at least one of a base station, an external terminal, and a server over a mobile communication network. The wireless signal includes a voice call signal, an video call signal, or other various data generated by transmission or receipt of text/multimedia messages.

The wireless Internet module 113 is a module for wirelessly accessing the Internet. The wireless Internet module 113 is embedded in the electronic device 100 or positioned outside the electronic device 100. Various wireless technologies are used, such as WLAN (Wireless LAN)(WiFi), Wibro (Wireless broadband), Wimax (World Interoperability for Microwave Access), or HSDPA (High Speed Downlink Packet Access).

The near-field communication module 114 enables near-field communications. Various near-field communication technologies are used, such as Bluetooth, RFID (Radio Frequency Identification), IrDA (Infrared Data Association), UWB (Ultra Wideband), or ZigBee.

The location information module 115 enables a user to identify or obtain the location of the electronic device 100. The location information module 115 includes a GPS (Global Position System) module. According to a current GPS technology, the location information module 115 obtains distances between one point (object) and three or more satellites and time that the distances are measured, and calculates three-dimensional location information regarding the latitude, longitude, and altitude of the point (object) by applying triangulation to the obtained distances. Another method can be also used that calculates the location and time using three satellites and calibrates the calculated location and time using another satellite. According to an embodiment, the location information module 115 continues to calculate the present location of the location information module 115 in real time and yields speeds based on the calculated location.

Referring to FIG. 1, the A/V input unit 120 inputs an audio or video signal and includes a camera 121 and a microphone 122. The camera 121 processes image frames, such as still images or motion pictures, as obtained by an image sensor in a video call mode or image capturing mode. The processed image frame is displayed on a display module 151.

According to an embodiment, the image frame processed by the camera 121 is stored in the memory 160 or transmitted to outside through the wireless communication unit 110. Two or more cameras 121 are provided depending on the configuration of the terminal.

The microphone 122 receives an external sound signal in a call mode, voice recording mode, or voice recognition mode and converts the sound signal into electrical voice data. The voice data is converted into a transmissible form and transmitted to a mobile communication base station through the mobile communication module 112. According to an embodiment, the microphone 122 includes various noise cancelling algorithms to remove noises that occur while receiving the external sound signal.

The user input unit 130 generates input data for a user to control the operation of the terminal. The user input unit 130 includes a key pad, a dome switch, a touch pad (resistive/capacitive types), a jog wheel, and a jog switch.

The sensing unit 140 detects current states of the electronic device 100, such as an opening/closing state of the electronic device 100, location of the electronic device 100, whether a user contacts the electronic device 100, orientation of the electronic device 100, and acceleration/deceleration of the electronic device 100, and generates sensing signals for controlling operation of the electronic device 100. For instance, in the case that the electronic device 100 is a sliding type phone, the sensing unit 140 senses whether the sliding phone is opened or closed. The sensing unit 140 also has functions of sensing whether the power supply 190 supplies power or whether an external device is coupled to the interface unit 170. The sensing unit 140 includes a proximity sensor 141.

The output unit 150 produces outputs associated with visual, auditory, or tactile senses. The output unit 150 includes a display module 151, a sound output module 152, an alarm unit 153, and a haptic module 154.

The display module 151 displays information processed by the electronic device 100. For example, in the case that the electronic device 100 is in a call mode, the display module 151 displays a UI (User Interface) or GUI (Graphic User Interface) associated with a call. In the case that the electronic device 100 is in an video call mode or in an image capturing mode, the electronic device 100 displays captured and/or received images or UI or GUI.

The display module 151 includes at least one of a liquid crystal display including a thin film transistor liquid crystal display, an organic light emitting diode display, a flexible display, and a three-dimensional (3D) display.

Some of the above-listed displays may be embodied as transparent or light-transmittive displays so that an outside can be seen through the displays. These displays are called “transparent displays”, and a representative example of the transparent displays includes a transparent LCD. A rear structure of the display module 151 may be implemented as a light transmittive structure. Due to this structure, a user may view an object positioned behind the terminal body through an area of the terminal body, which is occupied by the display module 151.

According to an embodiment, two or more display modules 151 are provided. For example, according to an embodiment, a plurality of display modules may be arranged on a surface of the electronic device 100 integrally or separately from each other by a predetermined distance, or may be positioned on different surfaces.

In the event that the display module 151 has a layered structure with a sensor sensing a touch (also referred to as “touch sensor”), thus constituting a “touch screen”, the display module 151 may be used as an input device as well. The touch sensor includes, for example, a touch film, a touch sheet, and a touch pad.

The touch sensor converts a pressure exerted to a specific area of the display module 151 or a capacitance created at a specific area of the display module 151 into an electrical input signal. The touch sensor may detect the pressure of a touch as well as the location and area of the touch.

When a touch is made on the touch sensor, corresponding signal(s) is sent to a touch controller. After processing the signal(s), the touch controller transmits corresponding data to the controller 180. Based on this, the controller 180 recognizes what area has been touched on the display module 151.

Referring to FIG. 1, a proximity sensor 141 is arranged at an inner portion of the electronic device 100, which is covered by the touch screen or at a portion adjacent to the touch screen. The proximity sensor 141 detects an object which is approaching a predetermined detection surface or an object adjacent to the detection surface using electromagnetic forces or infrared rays without any mechanical contact. The proximity sensor 141 has a longer lifespan than a contact-type sensor and provides high utilization.

The proximity sensor 141 includes, for example, a transmissive photoelectric sensor, a direct reflective photoelectric sensor, a mirror reflective photoelectric sensor, a high frequency oscillation proximity sensor, a capacitive proximity sensor, a magnetic proximity sensor, and an infrared proximity sensor.

In the case of a capacitive touch screen, when the point approaches the touch screen, an electric field is changed. Such change in electric field permits the approach of the point to be detected. In this example, the touch screen (touch sensor) may be classified as a proximity sensor.

For ease of illustration, an activity of allowing the point to be recognized as being positioned on the touch screen when the point is located adjacent to the touch screen without contacting the touch screen is referred to as “proximity touch”, and an activity of having the point actually contact the touch screen is referred to as “contact touch”. A location where the proximity touch is made on the touch screen means a location to which the point corresponds perpendicularly with respect to the touch screen when the point is subjected to a proximity touch.

The proximity sensor 141 senses a proximity touch and a proximity touch pattern (for example, distance, direction, speed, time, location, and shifting state of the proximity touch). Information corresponding to the operation and pattern of the sensed proximity touch may be output on the touch screen.

The sound output module 152 outputs audio data received by the wireless communication unit 110 or stored in the memory 160 in a call receipt or call mode, voice recording mode, voice recognition mode, or broadcast receipt mode. The sound output module 152 outputs sound signals associated with functions performed by the electronic device 100 (for example, a call receipt sound, message receipt sound, etc.). The sound output module 152 includes a receiver, a speaker, and a buzzer.

The alarm unit 153 outputs a signal for signaling that an event occurs in the electronic device 100. Examples of the event occurring in the electronic device 100 include call receipt, message receipt, key signal input, and touch input. The alarm unit 153 may signal the occurrence of the event in other forms than a video or audio signal, for example, by vibration. The video or audio signal may be output through the display module 151 or the sound output module 152 as well.

The haptic module 154 produces various tactile effects that can be felt by a user. Examples of the tactile effects include vibration. The strength and pattern of a vibration generated by the haptic module 154 may be controlled. For example, different vibrations may be first combined and then output, or sequentially output.

Besides vibration, the haptic module 154 may create various tactile effects, such as a stimulation effect by a pin arrangement moving perpendicular to a contact skin surface, a stimulation effect through a jetting force or suction force of air flowing through a jet hole or suction hole, a stimulation effect likely to rub the skin surface, a stimulation effect through a contact with an electrode, a stimulation effect using an electromagnetic force, and a cooling or heating effect using an exothermic or endothermic element.

The haptic module 154 may be embodied to be able to feel tactile effects through muscular sensory organs, such as a user's finger or arm as well as to transfer tactile effects through direct contact. According to an embodiment, two or more haptic modules 154 may be provided depending on how the electronic device 100 is configured.

The memory 160 stores a program for operating the controller 180 and temporarily stores input/output data (for example, phone books, messages, still images, motion pictures, etc.). The memory 160 stores data relating to various patterns of vibrations and sounds that are output when a touch is made on the touch screen.

The memory 160 includes at least one of a flash memory type storage, a hard disk type storage, a multimedia card micro type storage, a card type memory (for example, SD or XD), a RAM (Random Access Memory, RAM), an SRAM (Static Random Access Memory), a ROM (Read Only Memory, ROM), an EEPROM (Electrically Erasable Programmable Read Only Memory), a PROM (Programmable Read Only Memory), a magnetic memory, a magnetic disc, and an optical disc. According to an embodiment, the electronic device 100 may operate in association with a web storage that has a storage function like the memory 160 over the Internet.

The interface unit 170 functions as a path to the whole external devices connected to the electronic device 100. The interface unit 170 receives data or power from an external device and transmits the data or power to each component in the electronic device 100 or makes data transmitted from the electronic device 100 to an external device. For example, the interface unit 170 includes a wired/wireless headset port, an external recharger port, a wired/wireless data port, a memory card port, a port connecting a device having an identification module, an audio I/O (Input/Output) port, a video I/O (Input/Output) port, and an earphone port.

The identification module is a chip storing various information for authenticating a right to use the electronic device 100, and includes, for example, a user identity module (UIM), a subscriber identity module (SIM), and a universal subscriber identity module (USIM). A device having the identification module (also referred to as “identification device”) may be manufactured in the form of a smart card. Accordingly, the identification device may be connected to the electronic device 100 through a port.

The interface unit 170 may function as a path through which power is supplied from a cradle to the electronic device 100 when the electronic device 100 is connected to the cradle, or as a path through which various command signals are transmitted from the cradle to the electronic device 100. The power or command signals from the cradle may also operate as a signal indicating whether the electronic device 100 is correctly coupled with the cradle.

The controller 180 controls the overall operation of the electronic device 100. For example, the controller 180 performs control and process relating to voice call, data communication, and video call. The controller 180 includes a multimedia module 181 for playing multimedia. According to embodiments, the multimedia module 181 is included in the controller 180 or provided separately from the controller 180.

The controller 180 also performs a pattern recognition process that recognizes a handwriting input or drawing input on the touch screen as a letter and an image.

The power supply 190 supplies power from an external source or internal source to each component under control of the controller 180.

The embodiments as described herein may be embodied as software, hardware, or a combination thereof in a recording medium that may be read by a computer or its similar device.

As hardware implementations, the embodiments described herein may be implemented using at least one of ASICs (application specific integrated circuits), DSPs (digital signal processors), DSPDs (digital signal processing devices), PLDs (programmable logic devices), FPGAs (field programmable gate arrays, processors, controllers, microcontrollers, microprocessors, and electronic units for carrying out functions.

As software implementations, embodiments, such as procedures or functions, may be implemented along with a separate software module allowing at least one function or operation to be conducted. Software codes may be realized by a software application written in a proper program language. The software codes may be stored in the memory 160 and executed by the controller 180.

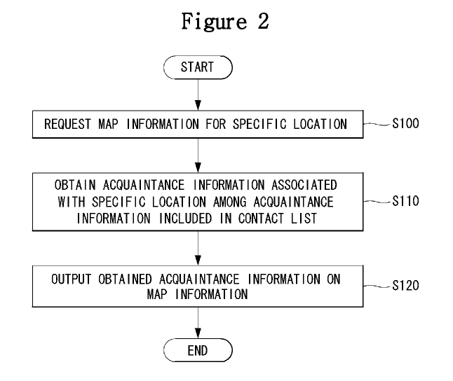

The configuration of the electronic device 100 has been heretofore described. Hereinafter, a method of operating the electronic device 100 according to an embodiment will be described with reference to FIG. 2.

FIG. 2 is a flowchart illustrating a method of operating an electronic device according to an embodiment of this disclosure.

In a method of operating an electronic device according to an embodiment, when map information regarding a specific location is requested, acquaintance information associated with the specific location among acquaintance information included in a contact list is acquired, and the acquired acquaintance information is displayed on the map information.

As shown in FIG. 2, the operating method includes at least one of a step of receiving map information for a specific location (S100), a step of the electronic device 100 acquiring acquaintance information associated with the specific location among acquaintance information included in a contact list (S110), and a step of displaying the acquired acquaintance information on the map information (S120). Each of the steps may be performed by the electronic device 100. Hereinafter, each step is described in greater detail.

In step S100, the electronic device 100 receives a request for the map information regarding the specific location.

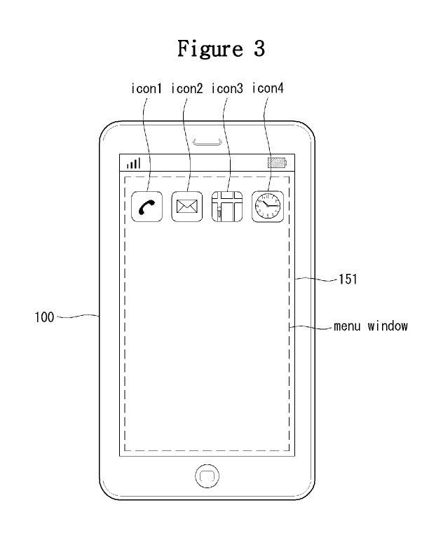

For instance, the electronic device 100 receives a request for executing an application requesting the map information from a user. Specifically, as shown in FIG. 3, the electronic device 100 executes a map application when Icon 3 is selected among icons displayed on a menu window.

As used herein, the “specific location” includes at least one of a current location of the electronic device 100, a target location desired by a user, and a user's location of interest. Hereinafter, for convenience of description, the specific location refers to a current location of the electronic device 100.

In step S100, the electronic device 100 receives a request for a current location of the electronic device 100 through the map application.

The electronic device 100 may obtain information on the current location of the electronic device 100 by various methods.

For example, the electronic device 100 acquires the information on current location through the location information module 115 described in connection with FIG. 1. For example, the electronic device 100 obtains the information on current location based on a strength of a signal received from a base station. For example, the electronic device 100 obtains the information on current location based on a combination of a GPS signal acquired through the location information module 115 and a signal received from a base station. For example, the electronic device 100 outputs the map information through the display module 151 so that a user selects the current location, and obtains the information on current location when the current location is selected by the user.

In step S110, the electronic device 100 obtains acquaintance information associated with the specific location among acquaintance information included in a contact list.

This is to determine whether an acquaintance stored in the contact list is located within a predetermined distance from the specific location.

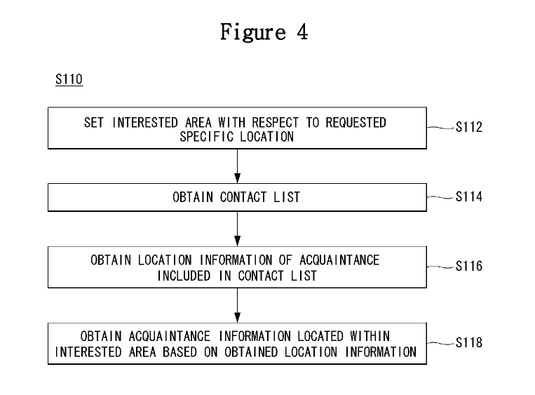

Step S110 is described in further detail with reference to FIG. 4.

FIG. 4 is a flowchart for describing step S110 more specifically.

Referring to FIG. 4, step S110 includes at least one of a step of setting an interested area with respect to the requested specific location (S112), a step of obtaining a contact list (S114), a step of obtaining location information of an acquaintance included in the contact list (S116), and a step of obtaining acquaintance information belonging to the interested area based on the acquired location information (S118). Hereinafter, each step is described in further detail.

In step S112, the electronic device 100 sets an interested area with respect to the requested specific location.

As used herein, the “interested area” refers to an area for searching an acquaintance stored in the contact list.

The electronic device 100 may set the interested area in various ways.

For instance, the electronic device 100 may set an area within a predetermined radius of the specific location as the interested area. For example, the electronic device 100 may receive the interested area with respect to the specific location from a user. In this case, the user may set the interested area in various shapes including a circular shape.

Hereinafter, for ease of description, an example is described where the electronic device 100 sets as the interested area an area within a predetermined radius of the specific location.

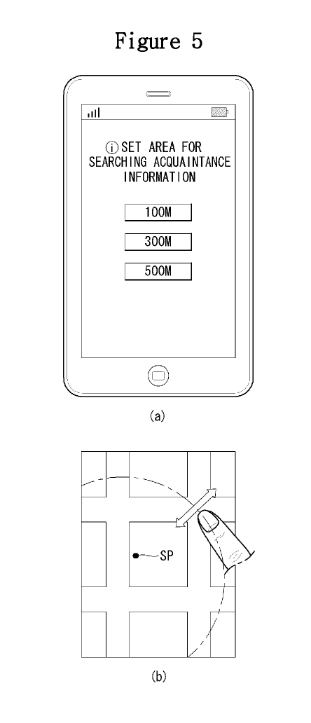

As shown in FIG. 5, the electronic device 100 outputs various user interfaces through the display module 151 so that a user may designate the interested area.

FIG. 5 illustrates examples of a user interface for setting an interested area according to an embodiment.

When the electronic device 100 outputs the user interface shown in FIG. 5A, a user may set an interested area by selecting or directly inputting a specific area. When the electronic device 100 outputs the user interface shown in FIG. 5B, the user may set a desired interested area by inputting the interested area in a touch-and-drag manner with respect to a specific location (SP).

Returning to FIG. 4, the electronic device 100 obtains a contact list (S114).

As used herein, the “contact list” includes any information that may provide acquaintance information. For instance, the contact list may be a phone book stored in the memory 160 of the electronic device 100. For instance, the contact list may include contacts stored in an email server used by a user of the electronic device 100. For example, the contact list may include contacts stored in a social network server used by a user of the electronic device 100.

As used herein, the “social network” is a research area involved in web science, and refers to a social relation structure that is made by interdependent ties between nodes, each of which corresponds to an individual or a group of people over the web. For example, the social network includes Twitter™, Face Book™, Me2 day™, blog, myspace, Foursquare™, etc.

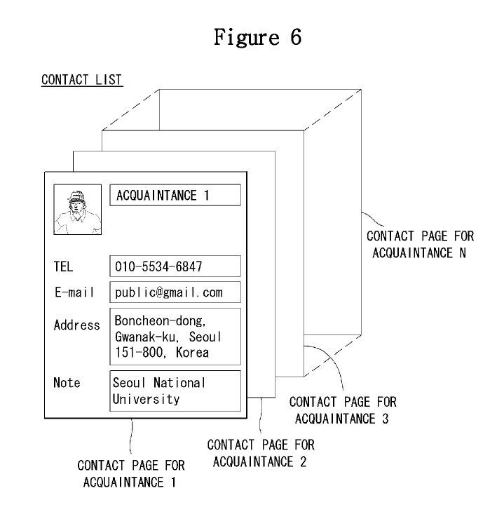

The contact list includes various information associated with acquaintances as shown in FIG. 6.

FIG. 6 is a view for describing a contact list according to an embodiment of this disclosure.

Referring to FIG. 6, a contact list includes information on acquaintance 1 to acquaintance n. For example, the contact page for acquaintance 1 includes an image, an identification name, a phone number, an email address, and a reference of acquaintance 1.

To acquire the contact list, the electronic device 100 performs at least one of a control operation of accessing the memory 160, a control operation of accessing an email server, and a control operation of accessing a social network server. By doing so, the electronic device 100 obtains information on the acquaintance through the contact list.

Accordingly, the electronic device 100 may acquire information on the acquaintance based on the acquired contact list.

Turning back to FIG. 4, the electronic device 100 obtains location information on an acquaintance included in the acquired contact list (S116).

The electronic device 100 may obtain the location information on the acquaintance included in the contact list in various ways.

For example, the electronic device 100 may obtain the location information on the acquaintance through address information included in the acquired contact list. Specifically, as shown in FIG. 6, the electronic device 100 may obtain location information on acquaintance 1, saying that an address of acquaintance 1 is 100-151, Bongcheon-dong, Kwanak-gu, Seoul, through the address information of acquaintance 1.

For example, the electronic device 100 may acquire location information of an acquaintance through references in the contact list. Specifically, as shown in FIG. 6, the electronic device 100 may acquire location information on acquaintance 1, saying that acquaintance 1's school is Seoul National University, through the reference of acquaintance 1.

For example, the electronic device 100 may obtain information on a current location of an acquaintance from a current location providing server.

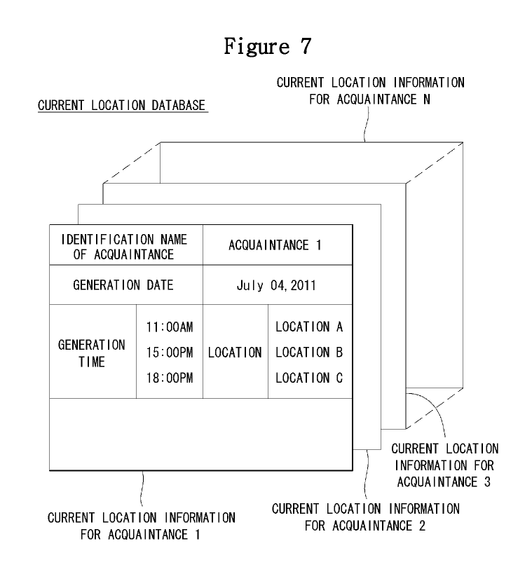

As used herein, the “current location providing server” refers to a server that receives current location information from a user periodically or whenever requested and provides the received information to other users. For this purpose, the current location providing server maintains a current location database. The current location database is described in greater detail with reference to FIG. 7.

FIG. 7 illustrates an example of the current location database according to an embodiment.

Referring to FIG. 7, the current location database includes location information of a specific user that is generated at a predetermined time of a predetermined date.

Accordingly, the electronic device 100 transmits identification information identifying an acquaintance included in the contact list to the current location providing server and acquires current location information of the acquaintance from the current location providing server.

Accordingly, the electronic device 100 may obtain location information of the acquaintance through the contact list or the current location providing server.

In the description on FIG. 4, step S112 may be independent from steps S114 and S116. For example, according to embodiments, steps S114 and S116 may be performed before or after step S112, or steps S112 may be performed simultaneously with steps S114 and S116.

The electronic device 100 obtains acquaintance information belonging to the interested area based on the location of the acquaintance (S118).

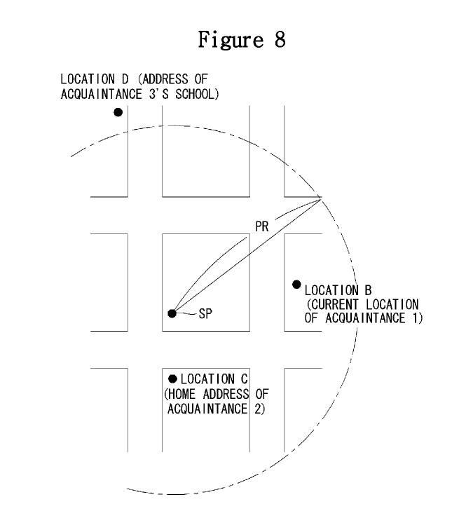

Step S118 is described in greater detail with reference to FIG. 8.

FIG. 8 is a view for specifically describing step S118.

Referring to FIG. 8, as described in connection with step S112, the electronic device 100 sets a predetermined area within a predetermined radius PR of the specific location SP, and obtains information on an acquaintance belonging to an interested area among acquaintances included in the contact list acquired in step S114. As shown in FIG. 8, location B, which is a current location of acquaintance 1, and location C, which is an address of acquaintance 2, are included in the interested area while location A, which is a past location of acquaintance 1, and location D, which is a location of a school of acquaintance 3, are not included in the interested area. Under this situation, the electronic device 100 acquires information on acquaintances 1 and 2 who belong to the interested area.

As the acquaintance information, the electronic device 100 obtains at least one of address information and/or current location information of the acquaintance, and an identification name and a contact of the acquaintance.

Hereinafter, step S120 is described in greater detail with reference to FIG. 3.

Turning back to FIG. 3, the electronic device 100 outputs the obtained acquaintance information on the map information (S120).

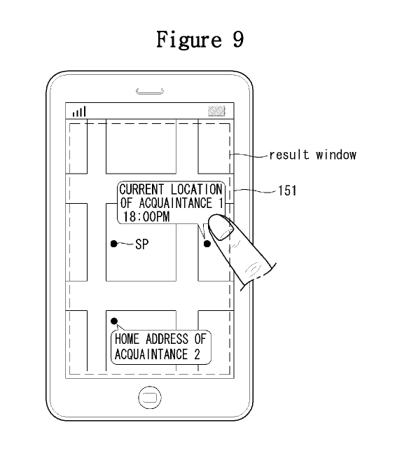

As shown in FIG. 9, the electronic device 100 obtains information on an acquaintance belonging to the interested area and outputs the information to correspond to the specific location.

FIG. 9 illustrates an example of a resultant window according to an embodiment.

Referring to FIG. 9, the electronic device 100 displays information on acquaintances located within the interested area of the specific location SP on the map information.

The electronic device 100 may provide information on how an acquaintance happened to be included in the interested area in outputting the acquaintance information. For instance, the electronic device 100 may provide information indicating that the current location of acquaintance 1 is included in the interested area, and a house of acquaintance 2 is positioned in the interested area.

In the event that the current location of an acquaintance is included in the interested area, the electronic device 100 may also provide information on when the information on the current location has been generated. For example, as shown in FIG. 9, it may be displayed that the current location information of acquaintance 1 has been generated at 8:00 PM.

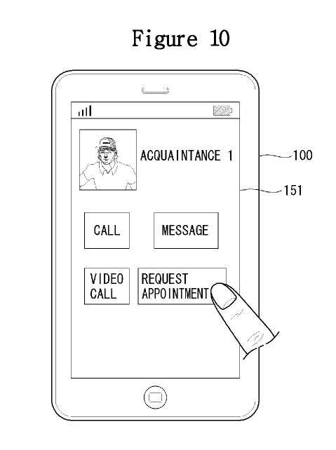

Further, the electronic device 100 may perform various interactions with a user while the resultant window is displayed. For example, in the case that the user selects acquaintance 1, the electronic device 100 may provide a user interface specified to acquaintance 1. For example, the electronic device 100 may output the user interface shown in FIG. 10.

FIG. 10 illustrates an exemplary user interface according to an embodiment.

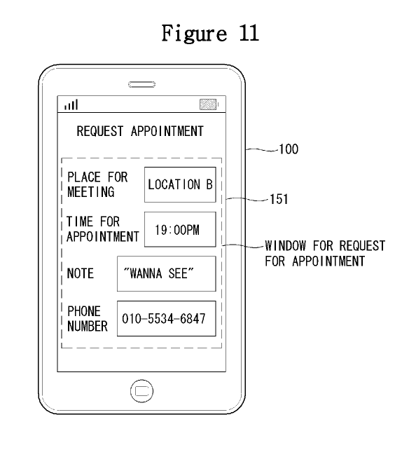

Referring to FIG. 10, the electronic device 100 may provide a function of “request for appointment” through a user interface. When a user selects the function of request for appointment, an appointment request message may be generated as shown in FIG. 11.

FIG. 11 is a view for describing that an appointment request message is generated according to an embodiment.

Referring to FIG. 11, a user may directly input each field, such as a place for meeting, an appointment time, and a note. Alternatively, the user may designate the place for meeting by touching a specific point on the map information.

Since the request for appointment is made to acquaintance 1, the electronic device 100 may automatically configure a phone number of acquaintance 1 as a recipient's phone number.

By doing so, the user may simply make an appointment request to acquaintance 1.

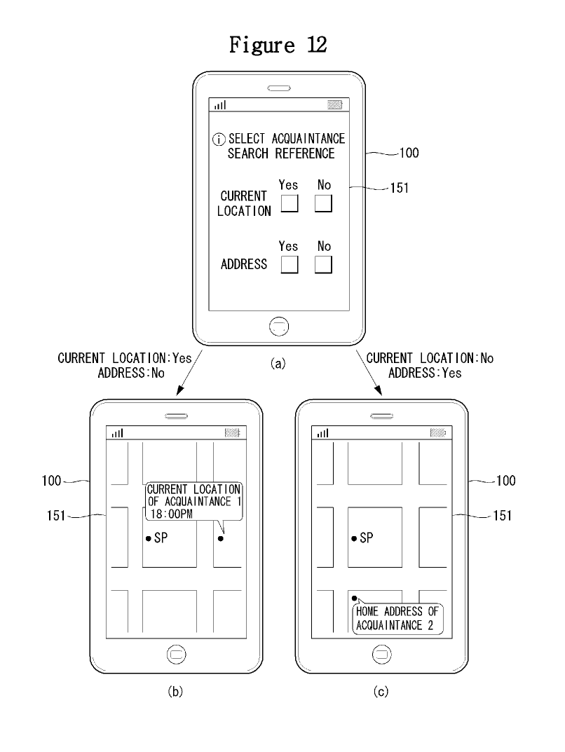

While searching an acquaintance included in the interested area, the electronic device 100 may receive a search range, which is described in greater detail with reference to FIG. 12.

FIGS. 12A, 12B, and 12C are views for describing an acquaintance search reference according to an embodiment.

Referring to FIG. 12A, the electronic device 100 outputs a user interface for selecting an acquaintance search reference. The acquaintance search reference includes at least one of a first search reference for searching an acquaintance whose current location is included in an interested area and a second search reference for searching an acquaintance whose home address is included in the interested area.

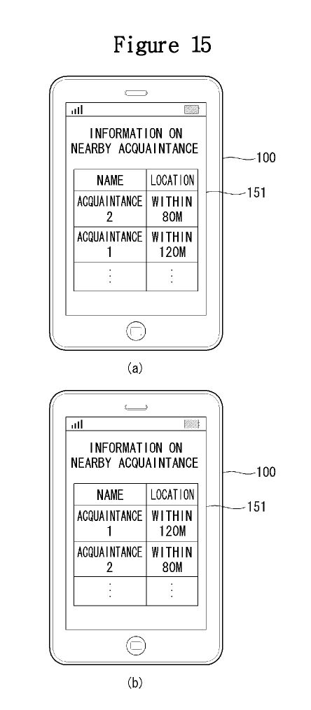

When the first search reference is selected as an acquaintance search reference, the electronic device 100 outputs information on acquaintance 1 whose current location is included in the interested area as shown in FIG. 15A.

When the second search reference is selected as the acquaintance search reference, the electronic device 100 outputs information on acquaintance 2 whose home address is included in the interested area as shown in FIG. 15B.

According to an embodiment, when both the first and second search references are selected as the acquaintance search reference, the electronic device 100 outputs information on acquaintances 1 and 2 as shown in FIG. 9.

As such, while searching an acquaintance belonging to the interested area, the electronic device 100 may provide user-desired acquaintance information by designating a search range.

As described above, when a user searches a specific location through a map application, the electronic device 100 may output acquaintance information associated with the specific area among acquaintance information included in a contact list. Further, when specific acquaintance information is selected among acquaintance information associated with the specific location, the electronic device 100 may provide detailed information on the specific acquaintance and may provide a user interface for requesting an appointment for the specific acquaintance, thus enhancing user convenience.

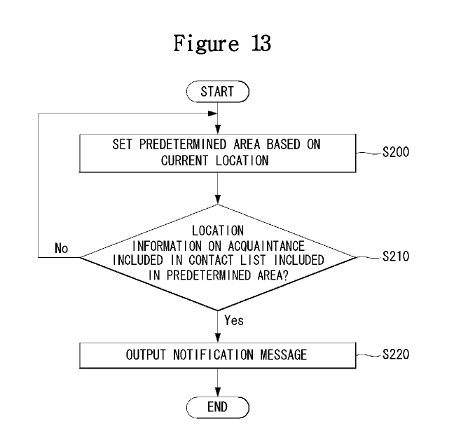

Hereinafter, an embodiment of this disclosure is described with reference to FIG. 13.

FIG. 13 is a flowchart for describing a method of operating an electronic device according to an embodiment of this disclosure.

The embodiment described in connection with FIGS. 1 to 12 provides acquaintance information associated with a specific location when a user executes a map application, and the embodiment described in connection with FIG. 13 provides a message of notifying that an acquaintance is located within a predetermined area of a current location.

Referring to FIG. 13, the method of operating an electronic device includes at least one of a step of setting a predetermined area based on a current location (S200), a step of determining whether location information on an acquaintance included in a contact list is included in the predetermined area (S210), and a step of outputting a notification message when it is determined that the location information on the acquaintance included in the contact list is included in the predetermined area (S220).

For ease of illustration, description is not repeated for those described in connection with FIGS. 1 to 12.

In step S210, the electronic device 100 determines whether location information on an acquaintance included in the contact list is included in the predetermined area.

Step S210 corresponds to steps S114 to S118 and detailed description thereof is not repeated.

When in step S210 the electronic device 100 determines that the location information on the acquaintance included in the contact list is not included in the predetermined area, the process turns back to step S200.

When in step S210 the electronic device 100 determines that the location information on the acquaintance included in the contact list is included in the predetermined area, the process enters into step S220 that is described below.

Upon determining that the location information on the acquaintance included in the contact list is included in the predetermined area, the electronic device 100 outputs a notification message (S220).

The notification messages notifies that the acquaintance included in the contact list is located within the predetermined area of the current location of the electronic device 100. A user can be aware that the acquaintance is located nearby through the notification message.

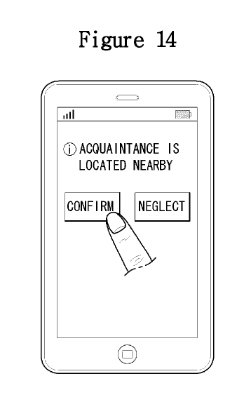

For example, the electronic device 100 may output the notification message shown in FIG. 14.

FIG. 14 illustrates an alarm message according to an embodiment of this disclosure.

Referring to FIG. 14, the electronic device 100 may notify that a specific acquaintance is located near the current location of the electronic device 100, and a user may acquire detailed information on the specific acquaintance by selecting an icon corresponding to “Conform”.

When a plurality of acquaintances are located near the electronic device 100, the electronic device 100 may output information on the acquaintances in various manners, which will be described below in greater detail with reference to FIG. 15.

FIG. 15 illustrates interfaces of outputting peripheral acquaintance information according to an embodiment of this disclosure.

Referring to 15A, the electronic device 100 sequentially outputs acquaintance information in the order away from an acquaintance closest to the electronic device 100 based on distances between the electronic device 100 and the acquaintances. By doing so, a user may intuitively identify what acquaintance is located closest to the user.

Referring to FIG. 15B, the electronic device 100 outputs peripheral acquaintance information in the order from a most frequently contacting acquaintance to a least frequently contacting acquaintance based on the contact frequency. As a result, a user may acquire information on an acquaintance who is close to the user as well as located near the user.

Although not shown in FIGS. 15A and 15B, the electronic device 100 may output direction information indicating where the peripheral acquaintances are located together with the peripheral acquaintance information, which enables a user to be intuitively aware of the direction in which a specific acquaintance is located with respect to the current location of the electronic device 100.

For example, although not shown, the electronic device 100 may also display the acquaintance information on the map information as shown in FIG. 9.

When a predetermined application is executed while outputting the notification message, the electronic device 100 may perform steps S200 to S220.

For example, upon recognizing an acquaintance located near the current location of the electronic device 100 while outputting the notification message, the electronic device 100 may automatically output the notification message.

According to the embodiment described in connection with FIGS. 13 to 15, the electronic device searches acquaintances near the current location of the electronic device 100, and, upon finding an acquaintance, notifies it to a user, so that the user may promptly obtain information on the acquaintances located around the user.

The embodiments described herein may be performed alone or in a combination thereof. The steps constituting each embodiment may be combined with the steps constituting the other embodiments.

For example, the user interfaces shown in FIGS. 10 to 12 described in connection with FIGS. 1 to 12 may also apply to the embodiment described in connection with FIGS. 13 to 15.

The embodiments of this disclosure may be implemented as computer-readable media. The media include program codes, data files, and data structures for embodying the embodiments, alone or in a combination thereof. Examples of the media include any media that may store and execute program codes, such as magnetic media, optical recording media, such as CDs and DVDs, ROMs, RAMs, and flash memories. Examples of the program codes include machine languages made by compilers as well as high-level languages executable by computers using an interpreter.

The embodiments of this disclosure have been explained above with reference to exemplary embodiments. It will be evident to those skilled in the art that various modifications may be made thereto without departing from the broader spirit and scope of the claims. Further, although the embodiments have been described in the context its implementation in particular environments and for particular applications, those skilled in the art will recognize that this disclosure's usefulness is not limited thereto and that the embodiments can be beneficially utilized in any number of environments and implementations. The foregoing description and drawings are, accordingly, to be regarded in an illustrative rather than a restrictive sense.

1-20. (canceled)

21. An electronic device, comprising:
a communication unit;
a display unit; and
a controller configured to:
receive, via the communication unit, a location of a specific electronic device corresponding to a specific user included in a contact list,
wherein the location of the specific electronic device is obtained at a first time point, and
display
a current location of the electronic device and a current location of the specific electronic device that are obtained at a second time point later than the first time point,
a time corresponding to the second time point, and
when the location of the specific electronic device obtained at the first time point is included in a predetermined area that is based on the current location of the electronic device, the location of the specific electronic device obtained at the first time point.

22. The electronic device of claim 21, wherein the location of the specific electronic device and the current location of the specific electronic device are transmitted from a location providing server.

23-25. (canceled)

26. A method for controlling an electronic device, comprising:
receiving, via a communication unit of the electronic device, a location of a specific electronic device corresponding to a specific user included in a contact list,
wherein the location of the specific electronic device is obtained at a first time point; and
displaying
a current location of the electronic device and a current location of the specific electronic device that are obtained at a second time point later than the first time point,
a time corresponding to the second time point, and
when the location of the specific electronic device obtained at the first time point is included in a predetermined area that is based on the current location of the electronic device, the location of the specific electronic device obtained at the first time point.

27. The method of claim 26, wherein the first location of the specific electronic device and the current location of the specific electronic device are transmitted from a location providing server.

28-30. (canceled)

31. An electronic device, comprising:
a display unit;
a communication unit; and
a controller configured to:
display a user interface for selecting at least one acquaintance search reference from a search list,
wherein the at least one acquaintance search reference includes a current location of a device of an acquaintance corresponding to the at least one acquaintance search reference and at least one other location associated with the acquaintance, and
when the at least one acquaintance search reference is selected, and when a location of the selected acquaintance search reference is located within a predetermined area that is based on a current location of the electronic device, display the current location of the electronic device and the location of the selected acquaintance search reference that is located within the predetermined area on a map displayed on the display unit.

32. The electronic device of claim 21, wherein the time corresponding to the second time point is displayed on or near the current location of the specific electronic device.

33. The method of claim 26, wherein the time corresponding to the second time point is displayed on or near the current location of the specific electronic device.
